(19) United States
(12) Patent Application Publication
(10) Pub. No.: US 2022/0173960 A1
(43) Pub. Date: Jun. 2, 2022

(54) VEHICLE DATA PROCESSING DEVICE, VEHICLE DATA PROCESSING SYSTEM, AND VEHICLE DATA PROCESSING METHOD

(71) Applicant: Mitsubishi Electric Corporation, Tokyo (JP)

(72) Inventors: Ayako OYANAGI, Tokyo (JP); Yasuaki TAKIMOTO, Tokyo (JP); Yasunori HOSHIHARA, Tokyo (JP)

(73) Assignee: Mitsubishi Electric Corporation, Tokyo (JP)

(21) Appl. No.: 17/442,988

(22) PCT Filed: Apr. 3, 2019
(86) PCT No.: PCT/JP2019/014821

§ 371 Date: Sep. 24, 2021

(51) Int. Cl. H04L 41/0654; H04L 67/12

(52) U.S. Cl. CPC H04L 41/0654; H04L 67/12

(57) ABSTRACT

An abnormal data detecting unit detects pieces of abnormal data outputted by pieces of vehicle-mounted equipment mounted in a vehicle, and outputs detail of abnormalities which have occurred in the pieces of vehicle-mounted equipment. An abnormality position acquiring unit acquires position information about the vehicle when abnormal data is detected by the abnormal data detecting unit. An abnormality occurrence information transmitting unit transmits pieces of abnormality occurrence information in which pieces of position information acquired by the abnormality position acquiring unit are associated with detail of abnormalities in the pieces of vehicle-mounted equipment, the detail being outputted from the abnormal data detecting unit, to a vehicle data processing server.

### TECHNICAL FIELD

The present disclosure relates to a vehicle data processing device, a vehicle data processing system, a vehicle data processing server, and a vehicle data processing method.

### BACKGROUND ART

For driving control of a vehicle for implementing autonomous driving or driving support, pieces of data from multiple pieces of vehicle-mounted equipment mounted in the vehicle are used. Vehicle-mounted equipment is a sensor, a radar, a camera, a communication module that receives data from outside the vehicle, or the like. There is a possibility that these pieces of data change into pieces of data having abnormal content that differ from the pieces of data which have been actually acquired by the pieces of vehicle-mounted equipment, because of data corruption caused by an environmental factor such as noise from outside the vehicle, or intentional falsification by malicious attackers. In a case in which driving control of the vehicle is performed by using abnormal data, because driving control having a degree of accuracy falling within an allowable range cannot be secured, and for example, when the vehicle is traveling along a curve with autonomous driving, its steering angle is erroneously controlled and the vehicle strays from the lane, the driving control of the vehicle should not continue to be performed by using abnormal data. Further, because when a communication module of a vehicle receives malicious attack data via a public wireless local area network (LAN) or a specific wireless access point such as a base station for mobile phones, an abnormality may occur in this communication module or the vehicle may cause dissemination of virus to other vehicles, the communication module should not be connected to any wireless access point with a problem.

When abnormal data as previously mentioned occurs or an abnormal communicating state is observed while a vehicle is travelling through a specific position, it is supposed that there is a certain external attack factor having an influence on the driving control of the vehicle, such as an environmental factor such as noise, or a point of attack by an attacker, at the point.

By the way, in Patent Literature 1, a self-driving control device that automatically performs one or more autonomous driving operations and stops at least one of autonomous driving operations currently being performed when a predetermined release request event occurs is described.

### CITATION LIST

### Patent Literature

Patent Literature 1: WO No. 2016/080452

### SUMMARY OF INVENTION

### Technical Problem

An external attack may take place repeatedly at a specific position. More specifically, there is a possibility that at the specific position, every time an unspecified vehicle travels, an external attack is made against the vehicle. However, the self-driving control device according to Patent Literature 1 does not take external attacks into consideration, and does not notify the outside of the vehicle of an abnormality which has occurred in vehicle-mounted equipment because of an external attack, to share the abnormality with other vehicles.

The present disclosure is made in order to solve the above-mentioned problem, and it is therefore an object of the present disclosure to provide a technique of transmitting information about an abnormality which has occurred in vehicle-mounted equipment of a vehicle at a specific position to outside the vehicle, to share the information with other vehicles.

### Solution to Problem

A vehicle data processing device according to the present disclosure includes: an abnormal data detecting unit for detecting abnormal data outputted by vehicle-mounted equipment mounted in a vehicle, and outputting detail of an abnormality which has occurred in the vehicle-mounted equipment; an abnormality position acquiring unit for acquiring position information about the vehicle when abnormal data is detected by the abnormal data detecting unit; and an abnormality occurrence information transmitting unit for transmitting abnormality occurrence information in which the position information acquired by the abnormality position acquiring unit is associated with detail of an abnormality in the vehicle-mounted equipment, the detail being outputted from the abnormal data detecting unit, to an outside of the vehicle.

### Advantageous Effects of Invention

According to the present disclosure, by transmitting an abnormality which has occurred in vehicle-mounted equipment of the vehicle to the outside of the vehicle, information about the abnormality which has occurred in the vehicle-mounted equipment of the vehicle at a specific position can be shared with other vehicles.

### BRIEF DESCRIPTION OF DRAWINGS

FIG. 1 is a diagram showing an example of the configuration of a vehicle data processing system according to Embodiment 1;

FIG. 2 is a block diagram showing an example of the configuration of a vehicle data processing device according to Embodiment 1;

FIG. 3 is a flowchart showing an example of an operation of transmitting abnormality occurrence information, the operation being performed by the vehicle data processing device according to Embodiment 1;

FIG. 4 is a diagram showing an example of a table which a processing content managing unit of the vehicle data processing device according to Embodiment 1 has;

FIG. 5 is a diagram showing an example of a database which the vehicle data processing server according to Embodiment 1 has;

FIG. 6 is a block diagram showing an example of the configuration of a vehicle data processing device according to Embodiment 2;

FIG. 7 is a diagram showing an example of a table which a priority managing unit of the vehicle data processing device according to Embodiment 2 has;

FIG. 8 is a block diagram showing an example of the hardware configuration of the vehicle data processing device according to each embodiment; and

FIG. 9 is a block diagram showing another example of the hardware configuration of the vehicle data processing device according to each embodiment.

### DESCRIPTION OF EMBODIMENTS

Hereinafter, in order to explain the present disclosure in greater detail, embodiments of the present disclosure will be described with reference to the accompanying drawings.

### Embodiment 1

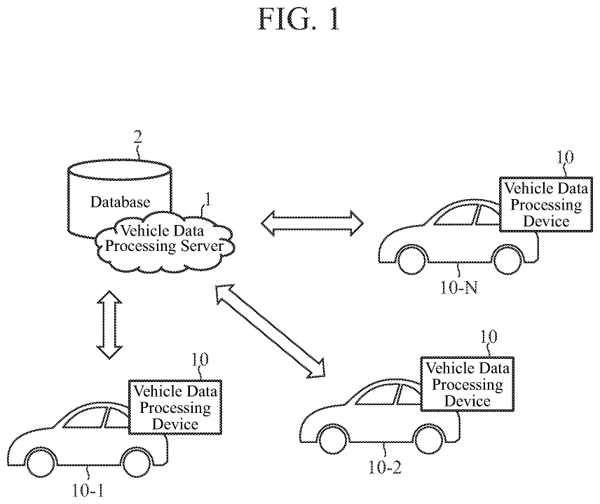

FIG. 1 is a diagram showing an example of the configuration of a vehicle data processing system according to Embodiment 1. The vehicle data processing system includes a vehicle data processing device 10 mounted in each of multiple vehicles 10-1 to 10-N (N is an arbitrary integer equal to or greater than 2), and a vehicle data processing server 1. The vehicle data processing server 1 and each vehicle data processing device 10 can perform wireless communications.

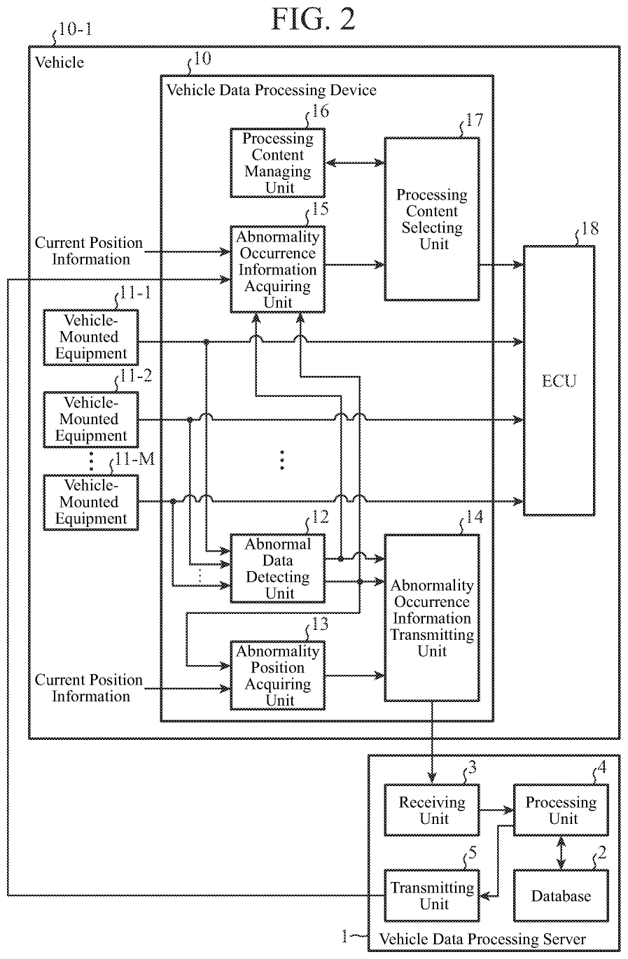

FIG. 2 is a block diagram showing an example of the configuration of a vehicle data processing device 10 according to Embodiment 1. The vehicle 10-1 includes a vehicle data processing device 10, one or more pieces of vehicle-mounted equipment 11-1 to 11-M (M is an arbitrary integer equal to or greater than 1), and an electronic control unit (ECU) 18 that performs autonomous driving, driving support, or the like.

Each of the other vehicles 10-2 to 10-N also includes a vehicle data processing device 10, pieces of vehicle-mounted equipment 11-1 to 11-M, and an ECU 18, like the vehicle 10-1.

The pieces of vehicle-mounted equipment 11-1 to 11-M are sensors, radars, cameras, wireless communication modules that receive data from outside the vehicle, or the likes. The pieces of vehicle-mounted equipment 11-1 to 11-M output pieces of data to the ECU 18 and an abnormal data detecting unit 12. The ECU 18 performs autonomous driving, driving support, or the like on the vehicle 10-1 by using the pieces of data from the pieces of vehicle-mounted equipment 11-1 to 11-M.

The vehicle data processing device 10 includes the abnormal data detecting unit 12, an abnormality position acquiring unit 13, an abnormality occurrence information transmitting unit 14, an abnormality occurrence information acquiring unit 15, a processing content managing unit 16, and a processing content selecting unit 17.

The pieces of vehicle-mounted equipment 11-1 to 11-M output abnormal data when attacked from the outside of the vehicle 10-1. Incorrect data may be included in the abnormal data. An attack from the outside of the vehicle 10-1 includes a disturbance in the normal operations of the pieces of the vehicle-mounted equipment 11-1 to 11-M, the disturbance being caused by an environmental factor such as noise outside the vehicle 10-1, a disturbance in the normal operations of the pieces of the vehicle-mounted equipment 11-1 to 11-M, the disturbance being caused by attack data transmitted from an attack point, or the like. Hereinafter, an environmental factor such as noise outside the vehicle 10-1, or an attack point and the like are referred to as a “factor outside vehicle.” As mentioned above, an attack caused by a factor outside vehicle may occur repeatedly at a specific position. More specifically, there is a possibility that an attack is made on the vehicle 10-1 every time the vehicle 10-1 travels through a specific position.

The abnormal data detecting unit 12 detects abnormal data outputted by the pieces of vehicle-mounted equipment 11-1 to 11-M. For example, the abnormal data detecting unit 12 detects abnormal data by comparing a type, an ID, or the like of the data outputted from the pieces of vehicle-mounted equipment 11-1 to 11-M with a type, an ID, or the like under normal conditions. Instead, the abnormal data detecting unit 12 may detect abnormal data by comparing a value of data outputted from the pieces of vehicle-mounted equipment 11-1 to 11-M with a value range under normal conditions. Instead, the abnormal data detecting unit 12 may detect abnormal data by checking whether the pieces of vehicle-mounted equipment 11-1 to 11-M are performing data output in a specific cycle or in accordance with a specific sequence. The abnormality detecting method used by the abnormal data detecting unit 12 is not limited to the above-mentioned examples.

When detecting that abnormal data has been outputted from one of the pieces of vehicle-mounted equipment 11-1 to 11-M, the abnormal data detecting unit 12 outputs abnormality occurrence equipment information showing the vehicle-mounted equipment that has outputted the abnormal data, and detail of an abnormality occurring in this vehicle-mounted equipment to the abnormality occurrence information transmitting unit 14 and the abnormality occurrence information acquiring unit 15. The abnormality occurrence equipment information is, for example, identification information such as the type or an individual number of the vehicle-mounted equipment. The abnormality detail is, for example, output of abnormal data or a rapid increase in the data rate.

Further, when detecting that abnormal data has been outputted from one of the pieces of vehicle-mounted equipment 11-1 to 11-M, the abnormal data detecting unit 12 outputs an abnormality detection signal showing that the abnormal data has been detected to the abnormality position acquiring unit 13, the abnormality occurrence information transmitting unit 14, and the abnormality occurrence information acquiring unit 15.

When receiving the abnormality detection signal from the abnormal data detecting unit 12, the abnormality position acquiring unit 13 acquires the current position information about the vehicle 10-1. The current position information is outputted by a not-illustrated car navigation device or the like. The abnormality position acquiring unit 13 outputs the acquired current position information, as abnormality occurrence position information showing the position where the abnormality has occurred in the one of the pieces of vehicle-mounted equipment 11-1 to 11-M, to the abnormality occurrence information transmitting unit 14.

When receiving the abnormality detection signal from the abnormal data detecting unit 12, the abnormality occurrence information transmitting unit 14 acquires the abnormality occurrence equipment information and the abnormality detail from the abnormal data detecting unit 12, and acquires the abnormality occurrence position information from the abnormality position acquiring unit 13. The abnormality occurrence information transmitting unit 14 generates abnormality occurrence information in which the abnormality occurrence position information is associated with the abnormality occurrence equipment information and the abnormality detail, and transmits the generated abnormality occurrence information to the vehicle data processing server 1.

Although the abnormality occurrence information transmitting unit 14 is triggered by the reception of the abnormality detection signal to start processing, the abnormality occurrence information transmitting unit 14 actually starts the processing after the processing of the abnormality position acquiring unit 13 is completed, because the abnormality position acquiring unit 13 is also triggered by the same abnormality detection signal to start the processing. By using, for example, a wireless communication module from the pieces of vehicle-mounted equipment 11-1 to 11-M, the abnormality occurrence information transmitting unit 14 transmits the abnormality occurrence information to the vehicle data processing server 1 at a time when no abnormality occurs in this wireless communication module.

Abnormal identification numbers each of which is assigned to a combination of vehicle-mounted equipment and detail of an abnormality which can occur may be provided in advance for the abnormality occurrence information transmitting unit 14. In this case, the abnormality occurrence information transmitting unit 14 selects the abnormal identification number corresponding to the abnormality occurrence equipment information and the abnormality detail which are acquired from the abnormal data detecting unit 12, from the abnormal identification numbers provided in advance. The abnormality occurrence information transmitting unit 14 then transmits abnormality occurrence information in which the selected abnormal identification number is associated with the abnormality occurrence position information acquired from the abnormality position acquiring unit 13 to the vehicle data processing server 1.

Further, the abnormality occurrence information transmitting unit 14 may acquire self-diagnostic results provided by self-diagnostic functions included in the pieces of vehicle-mounted equipment 11-1 to 11-M from the pieces of vehicle-mounted equipment 11-1 to 11-M. In this case, the abnormality occurrence information transmitting unit 14 may include the self-diagnostic result provided by vehicle-mounted equipment from which abnormal data output is detected, from the pieces of vehicle-mounted equipment 11-1 to 11-M, in the abnormality occurrence information. The self-diagnostic result is, for example, information showing the presence or absence of a failure of the vehicle-mounted equipment.

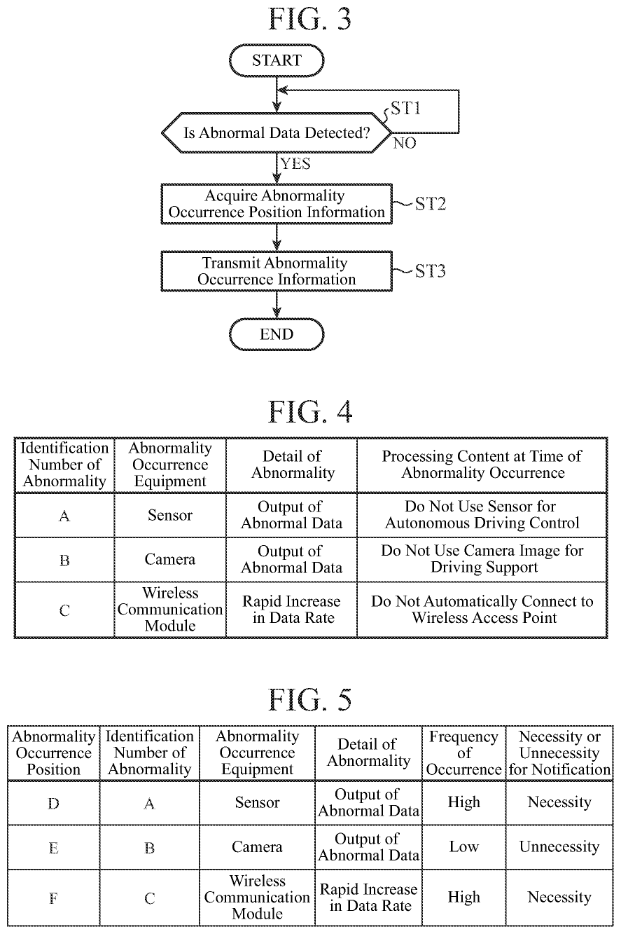

FIG. 3 is a flowchart showing an example of an operation of transmitting abnormality occurrence information, the operation being performed by the vehicle data processing device 10 according to Embodiment 1. When, for example, the accessory power of the vehicle 10-1 is turned on, the vehicle data processing device 10 starts the operation shown in the flowchart of FIG. 3, and repeatedly performs this operation until the accessory power is turned off

When in step ST1, the abnormal data detecting unit 12 detects that abnormal data is outputted from one of the pieces of vehicle-mounted equipment 11-1 to 11-M (when “YES” in step ST1), the abnormal data detecting unit 12 outputs an abnormality detection signal to the abnormality position acquiring unit 13, the abnormality occurrence information transmitting unit 14, and the abnormality occurrence information acquiring unit 15. When not detecting that abnormal data is outputted from any of the pieces of vehicle-mounted equipment 11-1 to 11-M (when “NO” in step ST1), the abnormal data detecting unit 12 repeats the operation of step ST1.

In step ST2, the abnormality position acquiring unit 13 receives the abnormality occurrence signal from the abnormal data detecting unit 12. The abnormality position acquiring unit 13 which has received the abnormality occurrence signal acquires the current position information about the vehicle 10-1, and outputs the acquired current position information, as abnormality occurrence position information, to the abnormality occurrence information transmitting unit 14.

In step ST3, the abnormality occurrence information transmitting unit 14 receives the abnormality detection signal from the abnormal data detecting unit 12. The abnormality occurrence information transmitting unit 14 which has received the abnormality occurrence signal acquires the abnormality occurrence equipment information and the abnormality detail from the abnormal data detecting unit 12, and also acquires the abnormality occurrence position information from the abnormality position acquiring unit 13. The abnormality occurrence information transmitting unit 14 then generates abnormality occurrence information including the abnormality occurrence equipment information, the abnormality detail, and the abnormality occurrence position information, and transmits the abnormality occurrence information to the vehicle data processing server 1.

In FIG. 2, the abnormality occurrence information acquiring unit 15 acquires abnormality occurrence information from the vehicle data processing server 1 by using, for example, a wireless communication module out of the pieces of vehicle-mounted equipment 11-1 to 11-M. The abnormality occurrence information includes abnormality occurrence equipment information, abnormality detail, and abnormality occurrence position information. The abnormality occurrence information may include, instead of abnormality occurrence equipment information and abnormality detail, an abnormal identification number assigned to a combination of vehicle-mounted equipment and detail of an abnormality which may occur. The abnormality occurrence position information included in the abnormality occurrence information may be spot information or area information.

Hereinafter, it is assumed that abnormality occurrence information from the vehicle data processing server 1 includes an abnormal identification number and abnormality occurrence position information.

When acquiring abnormality occurrence information from the vehicle data processing server 1, the abnormality occurrence information acquiring unit 15 acquires the current position information about the vehicle 10-1, and compares the current position information and the abnormality occurrence position information included in the abnormality occurrence information acquired from the vehicle data processing server 1. Within a time period when the current position of the vehicle 10-1 falls within a range based on the abnormality occurrence position information, the abnormality occurrence information acquiring unit 15 outputs the abnormal identification number included in the abnormality occurrence information to the processing content selecting unit 17.

For example, the vehicle data processing server 1 grasps the current position about the vehicle 10-1 at all times, and notifies the vehicle data processing device 10 of the abnormality occurrence information corresponding to the current position about the vehicle 10-1 as occasion demands, as will be mentioned later. Every time the vehicle 10-1 approaches an abnormality occurrence position, the abnormality occurrence information acquiring unit 15 acquires the abnormality occurrence information as notified from the vehicle data processing server 1.

Further, the vehicle data processing device 10 may inquire of the vehicle data processing server 1 whether there is abnormality occurrence information on a scheduled traveling route before the vehicle 10-1 starts traveling. In this case, the vehicle data processing server 1 collectively notifies the vehicle data processing device 10 of the vehicle 10-1 that has made the inquiry of all pieces of abnormality occurrence information on the scheduled traveling route. The abnormality occurrence information acquiring unit 15 collectively acquires all the pieces of abnormality occurrence information on the scheduled traveling route from the vehicle data processing server 1 before the vehicle 10-1 starts traveling.

Further, the abnormality occurrence information acquiring unit 15 may acquire an abnormality detection signal, abnormality occurrence equipment information, and abnormality detail from the abnormal data detecting unit 12. Within a time period when the abnormality occurrence information acquiring unit 15 receives an abnormality detection signal from the abnormal data detecting unit 12, the abnormality occurrence information acquiring unit 15 outputs either abnormality occurrence equipment information and abnormality detail, or an abnormal identification number corresponding to abnormality occurrence equipment information and abnormality detail to the processing content selecting unit 17.

For example, when a factor outside vehicle appears newly and there is no abnormality occurrence information corresponding to this factor outside vehicle in the vehicle data processing server 1, the abnormality occurrence information acquiring unit 15 cannot acquire abnormality occurrence information corresponding to this factor outside vehicle from the vehicle data processing server 1. In that case, the abnormality occurrence information acquiring unit 15 acquires detail of an abnormality in one of the pieces of vehicle-mounted equipment 11-1 to 11-M, the abnormality being caused to occur by the above-mentioned factor outside vehicle, from the abnormal data detecting unit 12.

The processing content managing unit 16 manages content of processing for either reducing an influence of an abnormality which may occur in the pieces of vehicle-mounted equipment 11-1 to 11-M when receiving an attack from the outside of the vehicle 10-1 on the vehicle 10-1, or preventing the influence from being exerted on the vehicle 10-1. The processing content managing unit 16 has a table, as shown in, for example, FIG. 4 in which processing contents for respective abnormal identification numbers are defined.

FIG. 4 is a diagram showing an example of the table which the processing content managing unit 16 of the vehicle data processing device 10 according to Embodiment 1 has. For example, for an abnormal identification number “A”, abnormality occurrence equipment “Sensor”, abnormality detail “Output of abnormal data”, and processing content at the time of the occurrence of an abnormality “Do not use sensor for autonomous driving control” are defined. The processing contents include presenting the use of abnormal data outputted by vehicle-mounted equipment for specific driving control which the ECU 18 performs (abnormal identification numbers “A” and “B”), and instructing the ECU 18 to control vehicle-mounted equipment which is a wireless communication module in such a way that the vehicle-mounted equipment does not connect to any wireless access point which is an attack point (an abnormal identification number “C”). The processing contents may be standardized for all vehicles, i.e., the whole of the vehicle data processing system, or may differ for each automobile manufacturer, each vehicle type, or each vehicle.

When, for example, vehicle-mounted equipment is newly added to the vehicle 10-1, the processing content managing unit 16 can add an abnormal identification number, the abnormality occurrence equipment, the detail of an abnormality, the processing content at the time of the occurrence of the abnormality, etc. which correspond to the newly added vehicle-mounted equipment to the table. Further, when an abnormal identification number, abnormality occurrence equipment, detail of an abnormality, processing content at the time of the occurrence of the abnormality, etc. are defined in accordance with a factor outside vehicle newly appearing in the vehicle data processing server 1, the processing content managing unit 16 can add the abnormal identification number, the abnormality occurrence equipment, the abnormality detail, the processing content at the time of the occurrence of the abnormality, etc., which are newly defined, to the table in accordance with an instruction from the vehicle data processing server 1.

When the abnormality occurrence information acquiring unit 15 outputs an abnormal identification number, the processing content selecting unit 17 selects processing content at the time of the occurrence of the abnormality corresponding to this abnormal identification number from the table managed by the processing content managing unit 16, and outputs the selected processing content to the ECU 18. Within a time period when the abnormality occurrence information acquiring unit 15 outputs an abnormal identification number, i.e., a time period when the current position of the vehicle 10-1 falls within a range based on the abnormality occurrence position information included in the abnormality occurrence information acquired from the vehicle data processing server 1, the processing content selecting unit 17 outputs the selected processing content to the ECU 18.

The ECU 18 performs either autonomous driving or driving support control on the vehicle 10-1 on the basis of the processing content from the processing content selecting unit 17.

For example, when the abnormality occurrence information acquiring unit 15 acquires the abnormality occurrence information including the abnormal identification number “A” from the vehicle data processing server 1, the abnormal identification number “A” is outputted from the abnormality occurrence information acquiring unit 15 to the processing content selecting unit 17. The processing content selecting unit 17 selects the processing content of “Do not use sensor for autonomous driving control” at the time of the occurrence of the abnormality corresponding to the abnormal identification number “A” from the table of FIG. 4 which the processing content managing unit 16 manages, and outputs the selected processing content of “Do not use sensor for autonomous driving control” to the ECU 18. The ECU 18 performs autonomous driving on the vehicle 10-1 without using the sensor which is the abnormality occurrence equipment out of the pieces of vehicle-mounted equipment 11-1 to 11-M. As a result, the vehicle data processing device 10 can prevent in advance an influence of an abnormality which may occur in the sensor when receiving an attack from the outside of the vehicle 10-1 on the autonomous driving of the vehicle 10-1.

Next, the configuration and the operation of the vehicle data processing server 1 will be explained.

As shown in FIG. 2, the vehicle data processing server 1 includes a database 2, a receiving unit 3, a processing unit 4, and a transmitting unit 5. After collecting abnormality occurrence information transmitted via the receiving unit 3 from each of the vehicle data processing devices 10 mounted in the vehicles 10-1 to 10-N, the processing unit 4 performs statistical processing on pieces of abnormality occurrence information and then stores the pieces of abnormality occurrence information in the database 2.

FIG. 5 is a diagram showing an example of the database 2 which the vehicle data processing server 1 according to Embodiment 1 has. The database 2 includes items, such as an abnormality occurrence position, an abnormal identification number, abnormality occurrence equipment, abnormality detail, the frequency of occurrence, and the necessity or unnecessity for notification. An abnormality occurrence position is either spot information or area information which is based on the abnormality occurrence position information included in abnormality occurrence information collected from a vehicle data processing device 10. An abnormal identification number is either an abnormal identification number included in the above-mentioned abnormality occurrence information, or an abnormal identification number corresponding to both the abnormality occurrence equipment information and the abnormality detail which are included in the above-mentioned abnormality occurrence information. Abnormality occurrence equipment and abnormality detail are either abnormality occurrence equipment information and abnormality detail which are included in the above-mentioned abnormality occurrence information, or abnormality occurrence equipment information and abnormality detail which correspond to the abnormal identification number included in the above-mentioned abnormality occurrence information. The frequency of occurrence is the frequency of occurrence of an abnormality which the processing unit 4 acquires by performing statistical processing on multiple pieces of abnormality occurrence information having the same detail, the pieces of abnormality occurrence information being collected from multiple vehicle data processing devices 10. In the example of FIG. 5, although the frequency of occurrence is expressed in two levels: “high” and “low”, the frequency of occurrence may be expressed in three or more levels. The necessity or unnecessity for notification is a result of the determination of whether or not to notify each of the vehicle data processing devices 10 of the abnormality occurrence information which the processing unit 4 acquires by comparing the frequency of occurrence of an abnormality and a threshold provided in advance. For example, when abnormality occurrence information having the abnormal identification number “A” at an abnormality occurrence position “D” is transmitted from many vehicle data processing devices 10 to the vehicle data processing server 1, i.e., when the frequency of occurrence is high, the processing unit 4 determines that the abnormality shown by this abnormality occurrence information results from a factor outside vehicle, and sets the necessity or unnecessity for notification to “necessity.” The processing unit 4 notifies each of the vehicle data processing devices 10 of the vehicles 10-1 to 10-N via the transmitting unit 5 of the abnormality occurrence information which is determined to be “necessity” for notification, so that the abnormality occurrence information is shared among the vehicles 10-1 to 10-N.

When a self-diagnostic result of the vehicle-mounted equipment which has outputted abnormal data, out of the pieces of vehicle-mounted equipment 11-1 to 11-M, is included in the abnormality occurrence information from a vehicle data processing device 10, the processing unit 4 may determine whether the abnormality shown by this abnormality occurrence information results from either a factor outside vehicle or a failure of the vehicle-mounted equipment which has outputted the abnormal data out of the pieces of vehicle-mounted equipment 11-1 to 11-M, on the basis of the self-diagnostic result. When determining that abnormality occurrence information collected from a vehicle data processing device 10 results from a failure of the vehicle-mounted equipment which has outputted abnormal data out of the pieces of vehicle-mounted equipment 11-1 to 11-M, the processing unit 4 discards the abnormality occurrence information without storing this abnormality occurrence information in the database 2. As a result, the vehicle data processing server 1 can collect only pieces of abnormality occurrence information about the pieces of vehicle-mounted equipment 11-1 to 11-M, the pieces of abnormality occurrence information resulting from an attack from the outside of the vehicles 10-1 to 10-N, and make a notification of the pieces of abnormality occurrence information.

Even when no self-diagnostic result is included in abnormality occurrence information, the vehicle data processing server 1 can selectively notify the vehicle data processing devices 10 of only the pieces of abnormality occurrence information about the pieces of vehicle-mounted equipment 11-1 to 11-M, the pieces of abnormality occurrence information resulting from an attack from the outside of the vehicles 10-1 to 10-N. As mentioned above, when the collected pieces of abnormality occurrence information are stored in the database, the processing unit 4 determines the necessity or unnecessity for notification in accordance with the frequencies of occurrence of abnormalities. Therefore, when a vehicle data processing device 10 transmits abnormality occurrence information resulting from a vehicle-specific failure of one of the pieces of vehicle-mounted equipment 11-1 to 11-M, the processing unit 4 determines that it is not necessary to provide a notification of this abnormality occurrence information because the frequency of occurrence of this abnormality is low.

The processing unit 4 grasps the current position of each of the vehicles 10-1 to 10-N at all times via the receiving unit 3, reads the abnormality occurrence information corresponding to the current position of each of the vehicles 10-1 to 10-N from the database 2 as occasion demands, and notifies the vehicle data processing device 10 of the abnormality occurrence information via the transmitting unit 5, for example.

Further, each of the vehicle data processing devices 10 of the vehicles 10-1 to 10-N may inquire the vehicle data processing server 1 whether there is abnormality occurrence information on the scheduled traveling route, before the vehicle starts traveling. In this case, the processing unit 4 collectively notifies the vehicle data processing device 10 that has made the inquiry of all the pieces of abnormality occurrence information on the scheduled traveling route.

As mentioned above, the vehicle data processing device 10 according to Embodiment 1 includes the abnormal data detecting unit 12, the abnormality position acquiring unit 13, and the abnormality occurrence information transmitting unit 14. The abnormal data detecting unit 12 detects abnormal data outputted by one of the pieces of vehicle-mounted equipment 11-1 to 11-M mounted in the vehicle 10-1, and outputs the detail of an abnormality occurring in the one of the pieces of vehicle-mounted equipment 11-1 to 11-M. The abnormality position acquiring unit 13 acquires the position information about the vehicle 10-1 when abnormal data is detected by the abnormal data detecting unit 12. The abnormality occurrence information transmitting unit 14 transmits abnormality occurrence information in which the position information acquired by the abnormality position acquiring unit 13 is associated with the abnormality detail of the one of the pieces of vehicle-mounted equipment 11-1 to 11-M, the abnormality detail being outputted from the abnormal data detecting unit 12, to the outside of the vehicle 10-1. With this configuration, the vehicle data processing device 10 can transmit information about an abnormality which may occur in any one of the pieces of vehicle-mounted equipment 11-1 to 11-M of the vehicle 10-1 because of reception of an attack from the outside of the vehicle 10-1 to the outside of the vehicle 10-1, and, as a result, the above-mentioned abnormality occurring in the one of the pieces of vehicle-mounted equipment 11-1 to 11-M of the vehicle 10-1 can be shared with other vehicles. Further, by using abnormality occurrence information transmitted from each of the vehicle data processing devices 10 of the vehicles 10-1 to 10-N, the vehicle data processing server 1 can identify and improve an environmental factor, such as noise causing abnormalities to occur in the pieces of vehicle-mounted equipment 11-1 to 11-M, and identify an attacker and detect vulnerabilities of communication infrastructure.

Further, the vehicle data processing device 10 according to Embodiment 1 includes the processing content managing unit 16 and the processing content selecting unit 17.

The processing content managing unit 16 manages the contents of processing each for either reducing an influence of an abnormality which may occur in any one of the pieces of vehicle-mounted equipment under 11-1 to 11-M when receiving an attack from the outside of the vehicle 10-1 on the vehicle 10-1, or preventing the influence from being exerted on the vehicle 10-1. The processing content selecting unit 17 selects the processing content corresponding to the abnormality detail of any one of the pieces of vehicle-mounted equipment 11-1 to 11-M outputted from the abnormal data detecting unit 12, from the processing contents managed by the processing content managing unit 16. With this configuration, the vehicle data processing device 10 can either reduce an influence of an abnormality which has occurred in the pieces of vehicle-mounted equipment 11-1 to 11-M because of a factor outside the vehicle 10-1 on the vehicle 10-1, or prevent the influence from being exerted on the vehicle 10-1.

Further, the vehicle data processing device 10 according to Embodiment 1 includes the abnormality occurrence information acquiring unit 15 for acquiring abnormality occurrence information as notified from the outside of the vehicle 10-1. When the position information included in the abnormality occurrence information acquired by the abnormality occurrence information acquiring unit 15 matches the current position information about the vehicle 10-1, the processing content selecting unit 17 selects the processing content corresponding to the abnormality occurrence information from the processing contents managed by the processing content managing unit 16. With this configuration, the vehicle data processing device 10 can prevent abnormalities which may occur in the pieces of vehicle-mounted equipment 11-1 to 11-M because of a factor outside the vehicle 10-1 before the abnormalities exert an influence on the control of the vehicle 10-1.

### Embodiment 2

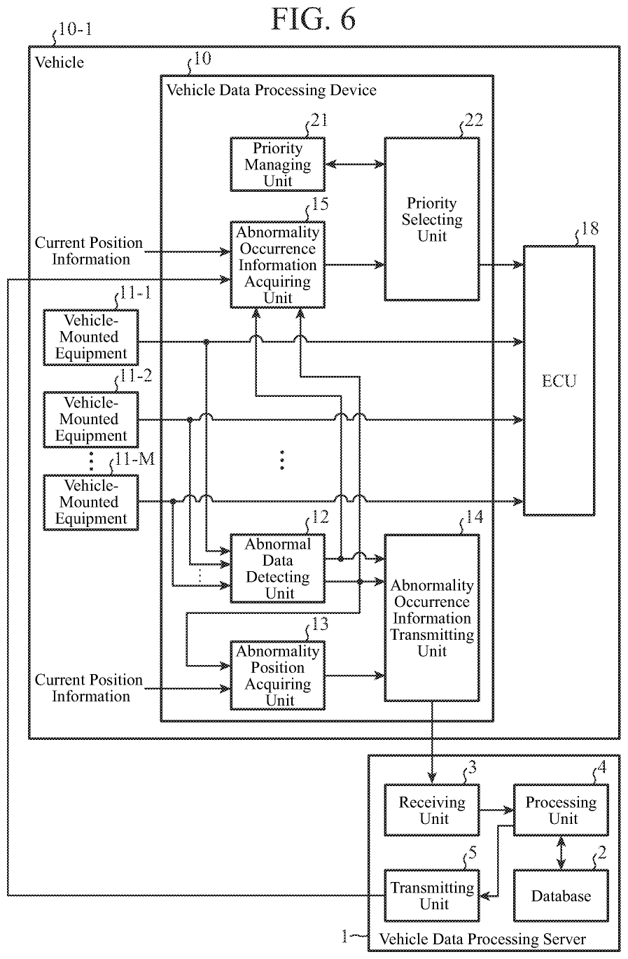

FIG. 6 is a block diagram showing an example of the configuration of a vehicle data processing device 10 according to Embodiment 2. The vehicle data processing device 10 according to Embodiment 2 is configured so as to include, instead of the processing content managing unit 16 and the processing content selecting unit 17 in the vehicle data processing device 10 of Embodiment 1 shown in FIG. 1, a priority managing unit 21 and a priority selecting unit 22. In FIG. 6, the same components as those shown in FIG. 1 or like components are denoted by the same reference signs, and an explanation of the components will be omitted hereinafter.

A vehicle data processing server 1 according to Embodiment 2 has the same configuration as the vehicle data processing server 1 of Embodiment 1 shown in FIG. 1.

When an abnormality occurs in one of pieces of vehicle-mounted equipment 11-1 to 11-M, the vehicle data processing device 10 of Embodiment 2 reduces the priority of abnormal data outputted by the vehicle-mounted equipment in which the abnormality has occurred, thereby causing an ECU 18 not to perform autonomous driving or driving support using the abnormal data.

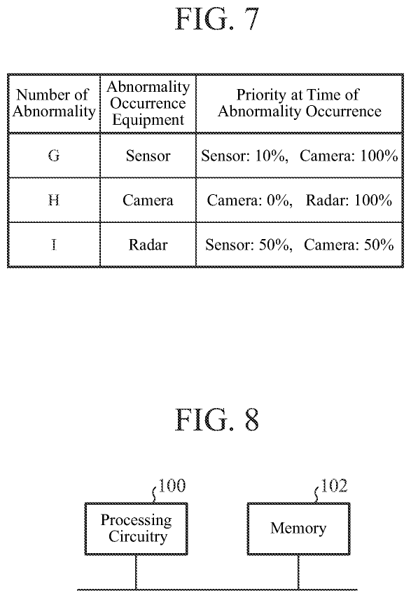

The priority managing unit 21 performs management while assigning a priority to each of the pieces of vehicle-mounted equipment 11-1 to 11-M mounted in the vehicle 10-1. The priority managing unit 21 has a table as shown in, for example, FIG. 7 in which a priority for each abnormal identification number is defined.

FIG. 7 is a diagram showing an example of the table which the priority managing unit 21 of the vehicle data processing device 10 according to Embodiment 2 has. For example, for an abnormal identification number “H”, abnormality occurrence equipment “camera” and priorities at the time of the occurrence of an abnormality “0% to camera, 100% to radar” are defined. In the example of FIG. 7, the rate of data use of vehicle-mounted equipment which is shown by each abnormal identification number and in which an abnormality can occur is managed as a priority. In the case of the abnormal identification number “H”, when performing autonomous driving or driving support, the ECU 18 uses data about a radar under normal operating conditions, instead of using data about a camera in which an abnormality caused by a factor outside vehicle has occurred. Further, in the case of an abnormal identification number “G”, when performing autonomous driving or driving support, the ECU 18 reduces the rate of data use of a sensor in which an abnormality caused by a factor outside vehicle has occurred from 100% to 10%, and maintains the rate of data use of the camera under normal operating conditions at 100%.

The abnormality occurrence information acquiring unit 15 outputs either abnormality occurrence equipment information and abnormality detail which the abnormality occurrence information acquiring unit has acquired from either the vehicle data processing server 1 or an abnormal data detecting unit 12 of the vehicle 10-1, or an abnormal identification number corresponding to the abnormality occurrence equipment information and the abnormality detail to the priority selecting unit 22, like that of Embodiment 1.

Hereinafter, it is assumed that the abnormality occurrence information acquiring unit 15 outputs an abnormal identification number.

When the abnormality occurrence information acquiring unit 15 outputs an abnormal identification number, the priority selecting unit 22 selects the priorities at the time of the occurrence of an abnormality, the priorities corresponding to this abnormal identification number, from the table managed by the priority managing unit 21. The priority selecting unit 22 selects vehicle-mounted equipment which substitutes for the vehicle-mounted equipment from which the output of abnormal data has been detected, from the pieces of vehicle-mounted equipment 11-1 to 11-M, on the basis of the selected priorities, and outputs a result of the selection to the ECU 18. Within a time period when the abnormality occurrence information acquiring unit 15 outputs an abnormal identification number, the priority selecting unit 22 outputs a selection result to the ECU 18.

Using the pieces of data outputted by the pieces of vehicle-mounted equipment 11-1 to 11-M on the basis of the priorities outputted by the priority selecting unit 22, the ECU 18 performs autonomous driving or driving support control on the vehicle 10-1.

For example, when the abnormality occurrence information acquiring unit 15 acquires abnormality occurrence information including the abnormal identification number “H” from the vehicle data processing server 1, the abnormal identification number “H” is outputted from the abnormality occurrence information acquiring unit 15 to the priority selecting unit 22. The priority selecting unit 22 acquires the priorities “0% to sensor, 100% to radar” at the time of the occurrence of an abnormality, the priorities corresponding to the abnormal identification number “H”, from the table of FIG. 7 managed by the priority managing unit 21, and outputs the rates of data use based on the acquired priorities to the ECU 18. On the basis of the rates of data use from the priority selecting unit 22, the ECU 18 does not use the data of the camera for autonomous driving or driving support, but uses only the data of the radar to detect obstacles in the vicinity of the vehicle 10-1. Although the ECU 18 can determine whether each obstacle is an object or a person by simply using the data of the camera, but cannot determine whether each obstacle is an object or a person when using the data of the radar. Therefore, although it becomes difficult for the ECU 18 to perform autonomous driving or driving support, such as “traveling while negotiating around obstacles when each obstacle is an object” or “stopping traveling when an obstacle is a person”, the ECU can continuously perform autonomous driving or driving support itself

As mentioned above, the vehicle data processing device 10 according to Embodiment 2 includes the priority managing unit 21 and the priority selecting unit 22. The priority managing unit 21 performs management while assigning a priority to each of the pieces of vehicle-mounted equipment 11-1 to 11-M mounted in the vehicle 10-1. The priority selecting unit 22 selects vehicle-mounted equipment which substitutes for vehicle-mounted equipment from which abnormal data is detected by the abnormal data detecting unit 12, from the pieces of vehicle-mounted equipment 11-1 to 11-M, on the basis of the priorities managed by the priority managing unit 21. With this configuration, the data processing device 10 can either reduce an influence of an abnormality which has occurred in the pieces of vehicle-mounted equipment 11-1 to 11-M on the vehicle 10-1, or prevent the influence from being exerted on the vehicle 10-1.

Further, according to Embodiment 2, when the position information included in abnormality occurrence information acquired by the abnormality occurrence information acquiring unit 15 matches the current position information about the vehicle 10-1, the priority selecting unit 22 selects vehicle-mounted equipment which substitutes for the vehicle-mounted equipment corresponding to the abnormality occurrence equipment information included in the abnormality occurrence information, from the pieces of vehicle-mounted equipment 11-1 to 11-M, on the basis of the priorities managed by the priority managing unit 21. With this configuration, the vehicle data processing device 10 can prevent abnormalities which may occur in the pieces of vehicle-mounted equipment 11-1 to 11-M because of a factor outside the vehicle 10-1 before the abnormalities exert an influence on the vehicle 10-1.

Finally, the hardware configuration of the vehicle data processing device 10 and the vehicle data processing server 1 according to each of the embodiments will be explained.

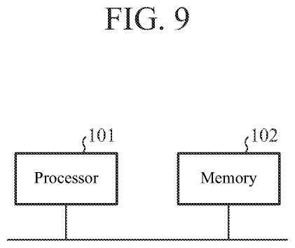

FIGS. 8 and 9 are diagrams showing examples of the hardware configuration of the vehicle data processing device 10 according to each of the embodiments. The processing content managing unit 16 and the priority managing unit 21 in the vehicle data processing device 10 are implemented by a memory 102. The functions of the abnormal data detecting unit 12, the abnormality position acquiring unit 13, the abnormality occurrence information transmitting unit 14, the abnormality occurrence information acquiring unit 15, the processing content selecting unit 17, and the priority selecting unit 22 in the vehicle data processing device 10 are implemented by a processing circuit. More specifically, the vehicle data processing device 10 includes a processing circuit for implementing the above-mentioned functions. The processing circuit may be a processing circuit 100 as hardware for exclusive use or a processor 101 that executes a program stored in the memory 102.

In the case in which the processing circuit is hardware for exclusive use, as shown in FIG. 8, the processing circuit 100 is, for example, a single circuit, a composite circuit, a programmable processor, a parallel programmable processor, an application specific integrated circuit (ASIC), a field programmable gate array (FPGA), or a combination of these circuits. The functions of the abnormal data detecting unit 12, the abnormality position acquiring unit 13, the abnormality occurrence information transmitting unit 14, the abnormality occurrence information acquiring unit 15, the processing content selecting unit 17, and the priority selecting unit 22 may be implemented by multiple processing circuits 100, or may be implemented collectively by a single processing circuit 100.

In the case where the processing circuit is the processor 101, as shown in FIG. 9, the functions of the abnormal data detecting unit 12, the abnormality position acquiring unit 13, the abnormality occurrence information transmitting unit 14, the abnormality occurrence information acquiring unit 15, the processing content selecting unit 17, and the priority selecting unit 22 are implemented by software, firmware, or a combination of software and firmware. The software or the firmware is described as a program and the program is stored in the memory 102. The processor 101 implements the function of each of the units by reading and executing a program stored in the memory 102. More specifically, the vehicle data processing device 10 includes the memory 102 for storing a program by which the steps shown in the flowchart of FIG. 3 are performed as a result when the program is executed by the processor 101. Further, it can be said that this program causes a computer to perform procedures or methods performed in the abnormal data detecting unit 12, the abnormality position acquiring unit 13, the abnormality occurrence information transmitting unit 14, the abnormality occurrence information acquiring unit 15, the processing content selecting unit 17, and the priority selecting unit 22.

Here, the processor 101 is a central processing unit (CPU), a processing device, an arithmetic device, a microprocessor, or the like.

The memory 102 may be a non-volatile or volatile semiconductor memory such as a random access memory (RAM), a read only memory (ROM), an erasable programmable ROM (EPROM), or a flash memory, a magnetic disc such as a hard disc or a flexible disc, or an optical disc such as a compact disc (CD) or a digital versatile disc (DVD).

Part of the functions of the abnormal data detecting unit 12, the abnormality position acquiring unit 13, the abnormality occurrence information transmitting unit 14, the abnormality occurrence information acquiring unit 15, the processing content selecting unit 17, and the priority selecting unit 22 may be implemented by hardware for exclusive use, and part of the functions may be implemented by software or firmware. As mentioned above, the processing circuit in the vehicle data processing device 10 can implement the above-mentioned functions by using hardware, software, firmware, or a combination of hardware, software, and firmware.

The hardware configuration of the vehicle data processing server 1 is the same as the hardware configuration shown in FIG. 8 or 9 in the drawing.

The database 2 in the vehicle data processing server 1 is implemented by the memory 102. The functions of the receiving unit 3, the processing unit 4, and the transmitting unit 5 in the vehicle data processing server 1 are implemented by a processing circuit. The processing circuit may be the processing circuit 100 as hardware for exclusive use or the processor 101 that executes a program stored in the memory 102. This program causes a computer to perform procedures or methods performed in the receiving unit 3, the processing unit 4, and the transmitting unit 5. Further, part of the functions of the receiving unit 3, the processing unit 4, and the transmitting unit 5 may be implemented by hardware for exclusive use, and part of the functions may be implemented by software or firmware.

It is to be understood that any combination of two or more of the above-mentioned embodiments can be made, various changes can be made in any component according to any one of the above-mentioned embodiments, or any component according to any one of the above-mentioned embodiments can be omitted within the scope of the present disclosure.

### INDUSTRIAL APPLICABILITY

The vehicle data processing system according to the present disclosure is suitable for use as a vehicle data processing system that shares an abnormality occurring in vehicle-mounted equipment because of a factor outside vehicle among multiple vehicles.

### REFERENCE SIGNS LIST

1: vehicle data processing server,
2: database,
3: receiving unit,
4: processing unit,
5: transmitting unit,
10: vehicle data processing device,
10-1 to 10-N: vehicle,
11-1 to 11-M: vehicle-mounted equipment,
12: abnormal data detecting unit,
13: abnormality position acquiring unit,
14: abnormality occurrence information transmitting unit,
15: abnormality occurrence information acquiring unit,
16: processing content managing unit,
17: processing content selecting unit,
18: ECU,
21: priority managing unit,
22: priority selecting unit,
100: processing circuit,
101: processor, and
102: memory.

1. A vehicle data processing device comprising:
processing circuitry
to detect abnormal data outputted by vehicle-mounted equipment mounted in a vehicle, and to output detail of an abnormality which has occurred in the vehicle-mounted equipment;
to acquire position information about the vehicle when abnormal data is detected;
to transmit abnormality occurrence information in which the acquired position information acquired by the is associated with detail of an abnormality in the vehicle-mounted equipment, to an outside of the vehicle;
to manage processing contents for either reducing an influence of an abnormality which may occur in the vehicle-mounted equipment when being attacked from an outside of the vehicle is received on the vehicle, or preventing the influence from being exerted on the vehicle; and
to select processing content corresponding to the abnormality detail of the vehicle-mounted equipment from the processing contents.

2.-3. (canceled)

4. The vehicle data processing device according to claim 1, wherein the processing circuitry acquires abnormality occurrence information as notified from an outside of the vehicle, wherein when position information included in the abnormality occurrence information matches a current position of the vehicle, the processing circuitry selects processing content corresponding to the abnormality occurrence information from the processing contents.

5. (canceled)

6. A vehicle data processing system comprising:
the vehicle data processing device according to claim 1; and
a vehicle data processing server to collect pieces of abnormality occurrence information from multiple vehicles in each of which the vehicle data processing device is mounted, and to perform statistical processing on the pieces of abnormality occurrence information, thereby databasing a relation between details of abnormalities each of which has occurred in vehicle-mounted equipment because of reception of an attack from an outside of a vehicle, and occurrence positions.

7. (canceled)

8. A vehicle data processing method comprising:
detecting abnormal data outputted by vehicle-mounted equipment mounted in a vehicle, and outputting detail of an abnormality which has occurred in the vehicle-mounted equipment;
acquiring position information about the vehicle when abnormal data is detected;
transmitting abnormality occurrence information in which the acquired position information is associated with detail of an abnormality in the vehicle-mounted equipment, to an outside of the vehicle;
managing processing contents for either reducing an influence of an abnormality which may occur in the vehicle-mounted equipment when being attacked from an outside of the vehicle is received on the vehicle, or preventing the influence from being exerted on the vehicle; and
selecting processing content corresponding to the abnormality detail of the vehicle-mounted equipment from the processing contents.
